(19) United States
(12) Patent Application Publication
(10) Pub. No.: US 2014/0005577 A1
(43) Pub. Date: Jan. 2, 2014

(54) AIRBAG FOR EXOSKELETON DEVICE

(71) Applicant: Amit GOFFER, Kiryat Tivon (IL)

(72) Inventor: Amit GOFFER, Kiryat Tivon (IL)

(21) Appl. No.: 13/535,485

(22) Filed: Jun. 28, 2012

(51) Int. Cl. A61H 1/02

(52) U.S. Cl. 601/34

(57) ABSTRACT

A motorized exoskeleton system for facilitating locomotion for a user, the system including a motorized exoskeleton device, one or a plurality of sensors to sense one or a plurality of parameters indicative of a state in which a user of the motorized exoskeleton device is falling, and an airbag unit comprising one or a plurality of airbags configured to deploy in response to the sensed state.

### FIELD OF THE INVENTION

The invention relates generally to motorized exoskeletons for restoring and/or assisting upright mobility among individuals with impaired lower limbs. In particular the invention relates to the inclusion of one or a plurality of airbags in motorized exoskeletons.

### BACKGROUND

Airbags are typically used in cars, but have also been developed for other vehicles (e.g. motorcycles) and even for other uses (e.g. for equestrians riding horses).

In addition to vehicular airbags, personal airbags have been developed to be worn on a person, typically the elderly, to cushion a fall. In some applications, airbags have been developed for workers who may need to be at a high height. In some applications, airbags have been developed for skiers, particularly for use in case of an avalanche.

Typically, in an airbag device, a signal may be sent to an inflator which may be in communication with an airbag control unit. In some embodiments an igniter may start a rapid nitrogen gas generating chemical reaction. In some airbags compressed nitrogen or argon may be used in conjunction with a pyrotechnic operated valve, or other propellants. Typically, the other propellants may include a combination of nitroguanidine, phase-stabilized ammonium nitrate (NH₄NO₃) or other nonmetallic oxidizer, and nitrogen-rich fuels.

Airbags may also contain burn rate modifiers, including an alkaline metal nitrate (NO3-) or nitrite (NO2-), dicyanamide or its salts, or sodium borohydride (NaBH4), among others. Airbags may also contain coolants and slag formers. The coolants and slag formers may be clay, silica, alumina, glass, or other known substances.

In some embodiments of the invention, airbags may include other propellants, for example, nitrocellulose based propellants which have high gas yield but relatively poor storage stability, or high-oxygen nitrogen-free organic compounds with inorganic oxidizers, including, dicarboxylic acids, tricarboxylic acids with chlorates (ClO3-) or perchlorates (ClO4-).

Personal airbags may be strapped around the body of an individual, e.g., around the head and/or around the waist area. Typically, personal airbags may inflate in around 0.1 seconds when the control unit detects that the airbag (or the individual protected by the airbag) is accelerating towards the ground.

About two million people in the USA alone are confined to wheelchairs that serve as their only means of mobility. As a result, their lives are full of obstacles such as stairs, rugged pavement and narrow passages. Furthermore, many disabled people lack the ability to remain in a standing position for long periods of time, and often have only limited upper-body movements.

Typically, attempts by disabled persons to remain standing for long periods of time often inflict hazardous health complications. In order to prevent rapid health deterioration, expensive equipment such as standing frames and trainers must often be used in addition to ample physio/hydro-therapy.

Typically, rehabilitation devices for disabled persons confined to wheelchairs as well as available devices in rehabilitation institutions are used for training purposes only.

### SUMMARY OF THE INVENTION

The invention relates generally a motorized exoskeleton system for facilitating locomotion for a user, the system including a motorized exoskeleton device, one or a plurality of sensors to sense one or a plurality of parameters indicative of a state in which a user of the motorized exoskeleton device is falling and an airbag unit comprising one or a plurality of airbags configured to deploy in response to the sensed state.

### BRIEF DESCRIPTION OF THE DRAWINGS

Examples are described in the following detailed description and illustrated in the accompanying drawings in which:

FIG. 1 is a schematic illustration of an airbag connected to an individual using a motorized exoskeleton device, according to an embodiment of the present invention;

FIG. 2a is a schematic illustration of an airbag connected to an individual using a motorized exoskeleton device, according to an embodiment of the present invention

FIG. 2b is a schematic illustration of an airbag connected to a motorized exoskeleton device according to an embodiment of the present invention;

FIG. 3 is a schematic illustration of an airbag unit connected to one or more sensors in a motorized exoskeleton device, according to an embodiment of the present invention;

FIG. 4 is a schematic illustration where an airbag is coupled to an individual using a motorized exoskeleton device and to a sensor in the motorized exoskeleton device, according to an embodiment of the present invention; and,

FIG. 5 is a flowchart of a method, according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the methods and apparatus. However, it will be understood by those skilled in the art that the present methods and apparatus may be practiced without these specific details. In other instances, well-known methods, procedures, and components have not been described in detail so as not to obscure the present methods and apparatus.

Although the embodiments of the invention disclosed and discussed herein are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method examples described herein are not constrained to a particular order or sequence. Additionally, some of the described method examples or elements thereof can occur or be performed at the same point in time.

Unless specifically stated otherwise, as apparent from the following discussions, it is appreciated that throughout the specification, discussions utilizing terms such as “adding”, “associating”, “selecting”, “evaluating”, “processing”, “computing”, “calculating”, “determining”, “designating”, “allocating” or the like, refer to the actions and/or processes of a computer, computer processor or computing system, or similar electronic computing device, that manipulate, execute and/or transform data represented as physical, such as electronic, quantities within the computing system's registers and/or memories into other data similarly represented as physical quantities within the computing system's memories, registers or other such information storage, transmission or display devices.

In the following detailed description, numerous specific details are set forth in order to provide a thorough understanding of embodiments of the invention presented below. However, it will be understood by those skilled in the art that the present invention may be practiced without these specific details. In other instances, well-known methods, procedures, and components have not been described in detail so as not to obscure the present embodiments of the invention of the invention.

A motorized exoskeleton device may be a motorized brace system for the lower body and lower limbs that may be typically attached to the body of a user, in some embodiments, under the clothes. In some embodiments of the invention, the motorized exoskeleton device may be attached to the body of the user on top of the clothing.

Typically, the motorized exoskeleton device may be useful in facilitating the locomotion of a user.

In some embodiments, the use of the motorized exoskeleton device may enable a user to restore some or all of their daily activities, especially stance and abilities, the abilities lost or diminished typically as the result of a disability.

In some embodiments of the invention, the motorized exoskeleton device may enable a non-disabled user to exert forces greater than their muscles can currently provide. In some embodiments, the motorized exoskeleton device may enable a non-disabled user to exert standard forces with less than typical effort.

In addition to stance and locomotion, the motorized exoskeleton device may support other mobility functions such as upright position to sitting position transitions and stairs climbing and descending.

The motorized exoskeleton device typically may suit users with disabilities such as paraplegia, quadriplegia, hemiplegia, polio-resultant paralysis, and in some applications, users with other difficult to severe mobility issues.

In some embodiments of the invention, the motorized exoskeleton device allows vertical stance and locomotion by means of an independent device that generally comprises a detachable light supporting structure as well as propulsion and control means.

Typically, the use of the motorized exoskeleton device may make it possible to relieve the incompetence of postural tonus as well as reconstituting the physiological mechanism of the podal support and walking. Consequently, the device, may, in some embodiments, reduce the need for wheelchairs among the disabled community. The motorized exoskeleton device may provide a better independence to the user and the ability to overcome obstacles such as stairs and/or other obstacles as are known in the art.

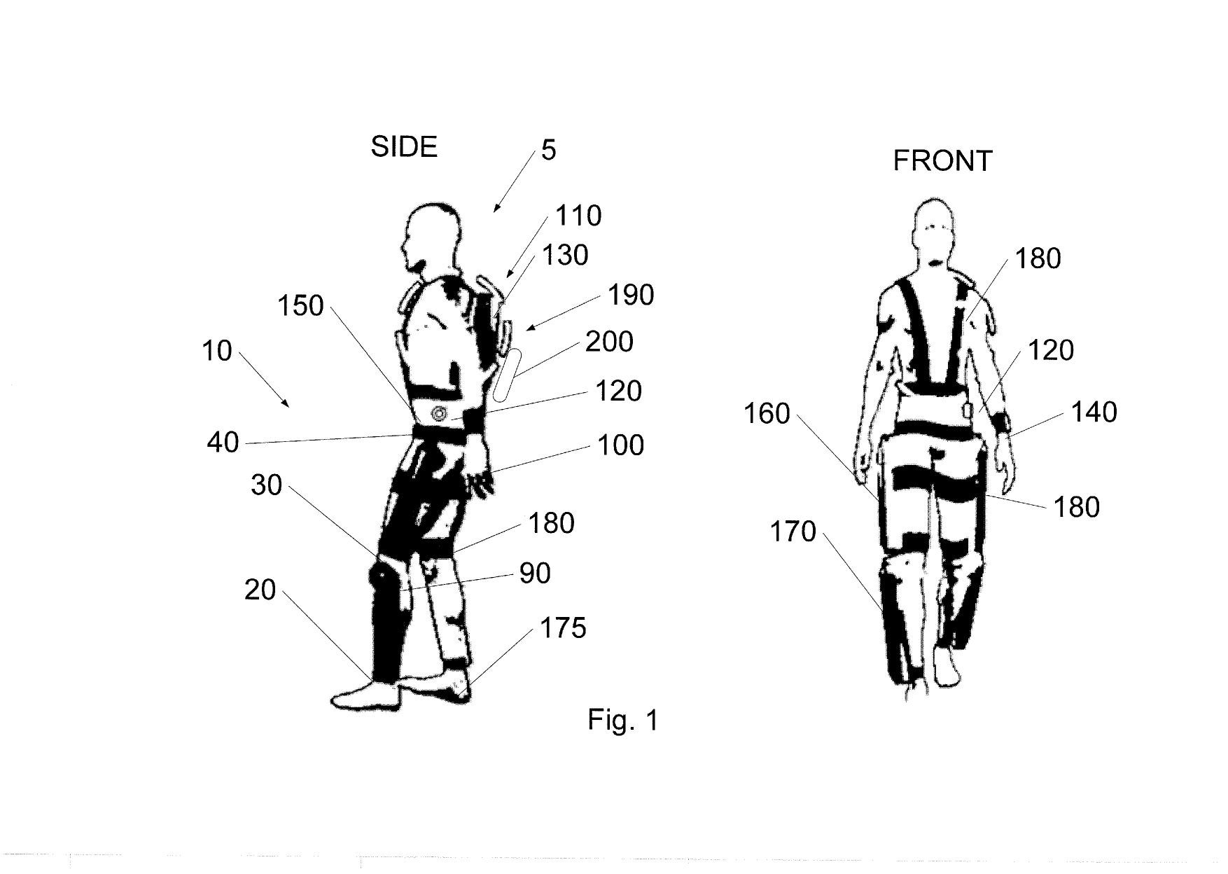

FIG. 1 is a schematic illustration of an example of a motorized exoskeleton device coupled to a user, The user may be coupled to an airbag, The schematic illustration shows the front view and side view of the user, according to an example of the invention.

Motorized exoskeleton device 10 may include a pair of limb members and/or braces, in some instances configured to be coupled to either side of the legs of the user. In some embodiments of the invention, there may be only a single limb member coupled to a single lower extremity of the user.

Motorized exoskeleton device 10 may include a control unit 110, mounted on the body of the user 5, in some embodiments, a person. In some examples, control unit 110 may be mounted, coupled to, or inserted in a backpack 130.

Control unit 110 may be configured to execute programs and algorithms, some of the programs and algorithms, as are known in the art, via an incorporated processor. In some embodiments of the invention, control unit 110 may interact with other devices, including sensors. The sensors may be components of or external to motorized exoskeleton device 10.

In some embodiments, the incorporated processer may constantly, or at intervals, interact with movements of the upper part of the body. With the incorporated processer constantly, or at intervals, interacting with movements of the upper part of the body, walking patterns and stability may be achieved with the help of user 5.

In some embodiments of the invention, control unit 110 may command motorized exoskeleton device 10 via power drivers. Typically, control unit 110 may contain or, in some examples, be coupled to dedicated electronic circuitry.

In some embodiments, control unit 110 may be coupled to one or a plurality of sensor unit which may include one or a plurality of sensors, e.g., a tilt sensor. In some instances the sensors include and/or may be similar to other sensors known in the art. In some embodiments of the invention, the sensor unit may monitor parameters of motorized exoskeleton device 10. In some examples, the sensors sense one or a plurality of parameters indicative of a state in which a user of the motorized exoskeleton device is falling, wherein falling may represent a safety concern to the user. The monitored parameters of motorized exoskeleton device 10 may include torso tilt angle, articulation angles, motor load, speed and direction of the user and/or exoskeleton device 10, warnings, and other parameters.

In some embodiments of the invention, sensor unit 120 may transfer information regarding monitored parameters of motorized exoskeleton device 10 to control unit 110 and/or processor via feedback interfaces. The feedback interfaces as are known in the art. In some examples, sensor unit 120 may transfer information regarding monitored parameters of motorized exoskeleton device 10 to other devices, as described below.

In some embodiments of the invention, motorized exoskeleton device may include one or plurality of joints. The one or plurality of joints in the motorized exoskeleton device 10 may include, for example, ankle joint 20, knee joint 30, or hip joint 40. In some embodiments of the invention, motorized exoskeleton device 10 may also be provided with one or a plurality of angle sensors for sensing, in some embodiments, a relative angle between segments connected by the one or plurality of joints: ankle joint 20, knee joint 30, or hip joint 40.

In some examples, an output signal from at least one sensor in sensor unit 120 may be communicated to control unit 110. The output signal may indicate a current relative angle between connected segments.

In some embodiments of the invention, sensor unit 120 may be mounted on user 5 or on a brace, as described below. Sensor unit 120 may be located on any component of motorized exoskeleton device 10 whose angle of tilt reflects the angle of tilt of the trunk support of motorized exoskeleton device 10. In some examples, the output signal from sensor unit 120 may indicate an angle between the trunk of the user and the vertical. In some embodiments, the output signal may indicate an angle between the whole exoskeleton and the vertical to the ground.

In some embodiments, motorized exoskeleton device 10 may include one or more additional auxiliary sensors. The auxiliary sensors may include one or a plurality of pressure-sensitive sensors. Typically, a pressure-sensitive sensor may measure a ground force exerted on motorized exoskeleton device 10. In some embodiments, the ground force sensor may be included in a surface designed for attachment to the bottom of the foot of a user.

Control unit 110 may be located in a backpack of motorized exoskeleton device 10, e.g., backpack 130. Alternatively, components of the control unit may be incorporated into various components of motorized exoskeleton device 10. In some examples, control unit 110 may include a plurality of intercommunicating electronic devices. The intercommunication between control unit 110 and plurality of intercommunicating electronic devices may be wired or wireless.

In some embodiments of the invention, communication between control unit 110 and components of motorized exoskeleton device 10 such as a knee motor unit 90 and/or a hip motor unit 100 and sensors, and/or other components of motorized exoskeleton device 10 may be wired or wireless.

Motorized exoskeleton device 10 may include a Man Machine Interface, MMI. In some embodiments of the invention, the MMI may be, for example, a remote control 140 through which the user controls modes of operation and parameters of motorized exoskeleton device 10. In some examples, the controlled modes of operation and parameters of motorized exoskeleton device 10 by a Man Machine Interface or remote control 140 may include mode, sitting mode and standing mode, or other modes known in the art.

Remote control 140 may include one or more pushbuttons, switches, touch-pads or other interfaces. In some embodiments of the invention, remote control 140 may include other similar manually operated controls that a user may operate. Typically, the operation of remote control 140 may generate an output signal, or other signals known in the art, for communication to control unit 110.

A communicated signal between remote control 140 and control unit 110 may indicate a user request to initiate or continue a mode of operation. For example, a communicated signal between remote control 140 and control unit 110 may indicate a command to initiate walking, or in some examples, a command to continue a walking forward, or other operations known in the art, when appropriate sensor signals are received. In some embodiments of the invention, a communicated signal between remote control 140 and control unit 110 may include a control for turning motorized exoskeleton device 10 on or off. In some embodiments, a communicated signal between remote control 140 and control unit 110 may include a control for turning motorized exoskeleton device to remain in a stand-by phase.

In some instances, remote control 140 may be designed for mounting in a location that is readily accessible by user 5. For example remote control 140 may be placed and/or secured in a particular location with a band or strap.

In some examples, remote control 140 may include several detached controls, each detached control in remote control 140 may be configured for communicating separately with control unit 110 and each detached control in remote control 140 may be configured to be mounted at a separate location on user 5 or on motorized exoskeleton device 10.

In some embodiments of the invention, user 5 may receive various indications through MMI or transfer the user's command and shift motor's gear according to his will to through another interface, e.g., a computer keyboard.

In some embodiments of the invention, motorized exoskeleton device 10 may include a power unit 190. In some embodiments of the invention, power unit 190 may be configured to be placed in, or coupled to, backpack 130. Power unit 190 may include rechargeable batteries and/or related circuitry. In some examples, power unit 190 may have an alternative power source. In some embodiments of the invention, power unit 190 may be powered by rechargeable batteries. In some examples, power unit 190 may be solar powered. In some embodiments, power unit 190 may provide power to peripheral devices.

In some embodiments, brace segments may be worn adjacent to parts of the body of user 5.

In some embodiments of the invention, the braces may include a pelvis brace 150. Pelvis brace 150 may be worn on the trunk of user 5. In some examples, the braces may include thigh braces 160. Thigh braces 160 may be worn adjacent to the thighs of the user. In some embodiments, the braces may include leg braces 170. Leg braces 170 may be worn adjacent to the calves of the user. In some examples, the braces may include feet braces 175. Feet braces 175 may be configured to be coupled to the feet of user 5. Stabilizing shoe braces may be attached to the bottom of the leg braces 170 and feet braces 175. Other braces configured to be coupled to other parts of user 5, as are known in the art may also be used.

Motorized exoskeleton device 10 may include straps 180. Straps 180 may, in some embodiments of the invention, ensure that each component brace described above of motorized exoskeleton device 10 attaches to an appropriate corresponding part of the body of user 5. In some embodiments, other methods of attaching or coupling component braces, described above, as are known in the art may also be used. In some embodiments of the invention, straps 180 may be made from a flexible material or fiber as are known in the art.

Typically, motion of the component brace may move the attached body part. In some embodiments, braces or other components of motorized exoskeleton device 10 may be adjustable so as to enable optimally fitting motorized exoskeleton device 10 to the body of a specific user. In some examples, the moved attached body part may not be able to move on its own. In some embodiments of the invention, the moved attached body part may otherwise be able to move on its own.

In some embodiments of the invention, the motorized exoskeleton device may be used in conjunction with other devices. Other devices may provide additional support and/or mobility. In some examples, other devices may provide other functions, as are known in the art.

In some embodiments, a motorized exoskeleton system may include the motorized exoskeleton device that may be used in conjunction with an air bag unit 200, air bag unit 200 described below. Air bag unit 200 may be coupled to user 5. In some embodiments, air bag unit 200 may be coupled to motorized exoskeleton device 10.

In some embodiments of the invention, airbag unit 200 coupled to motorized exoskeleton device 10 results in a system that may not require installation and the involvement of a qualified person.

In some examples, the airbag unit coupled to motorized exoskeleton device 10 and/or the airbag unit worn by user 5 is configured to be passive systems that may not require a conscious action by user 5 in order for the airbag to be deployed.

Motorized exoskeleton system, which includes the airbag unit, coupled to user 5 and/or to motorized exoskeleton device 10, is a flexible system and may be designed to deploy one or a plurality of airbags, in some embodiments, independent of task and environment.

A motorized exoskeleton system which includes the airbag unit 200, coupled to user 5 and/or to motorized exoskeleton device 10, is configured to be a relatively simple system that may not require special knowledge or training by user 5 to operate.

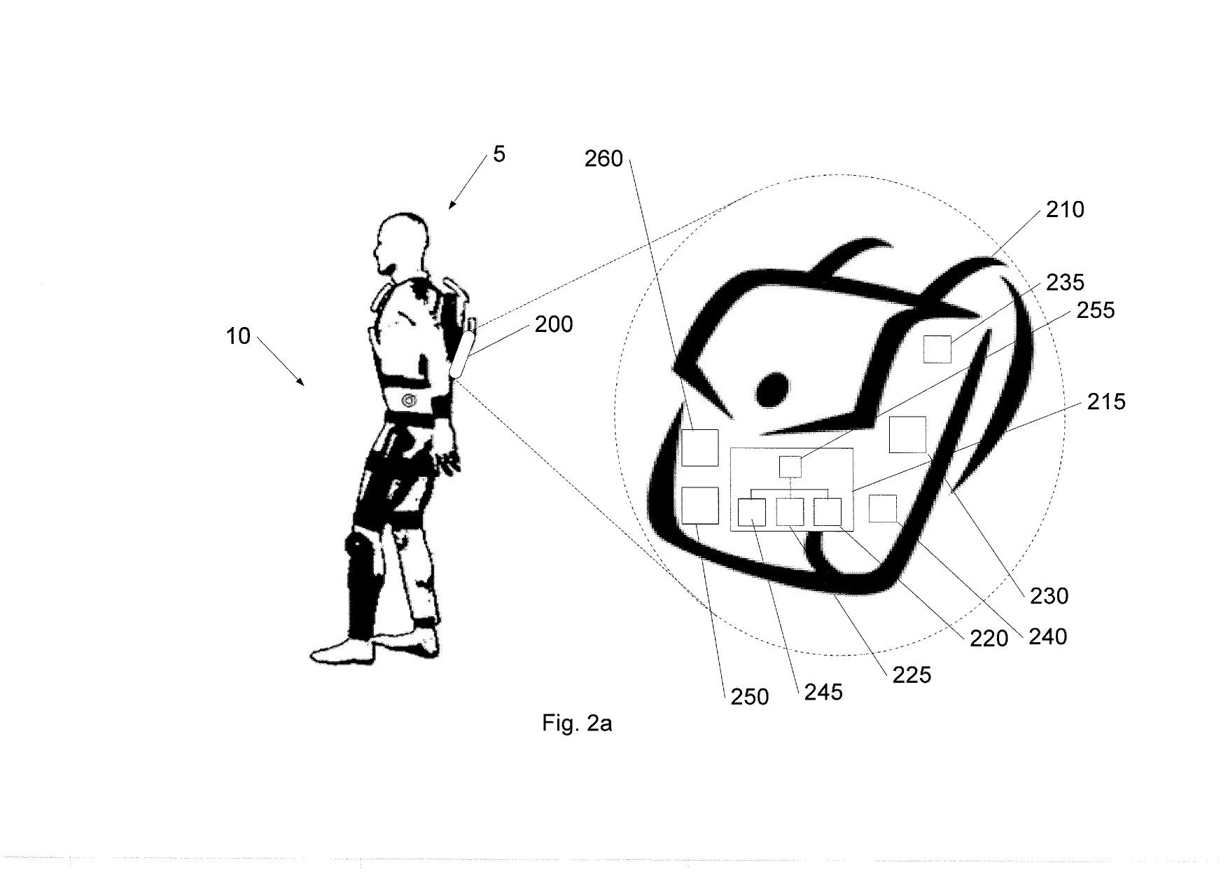

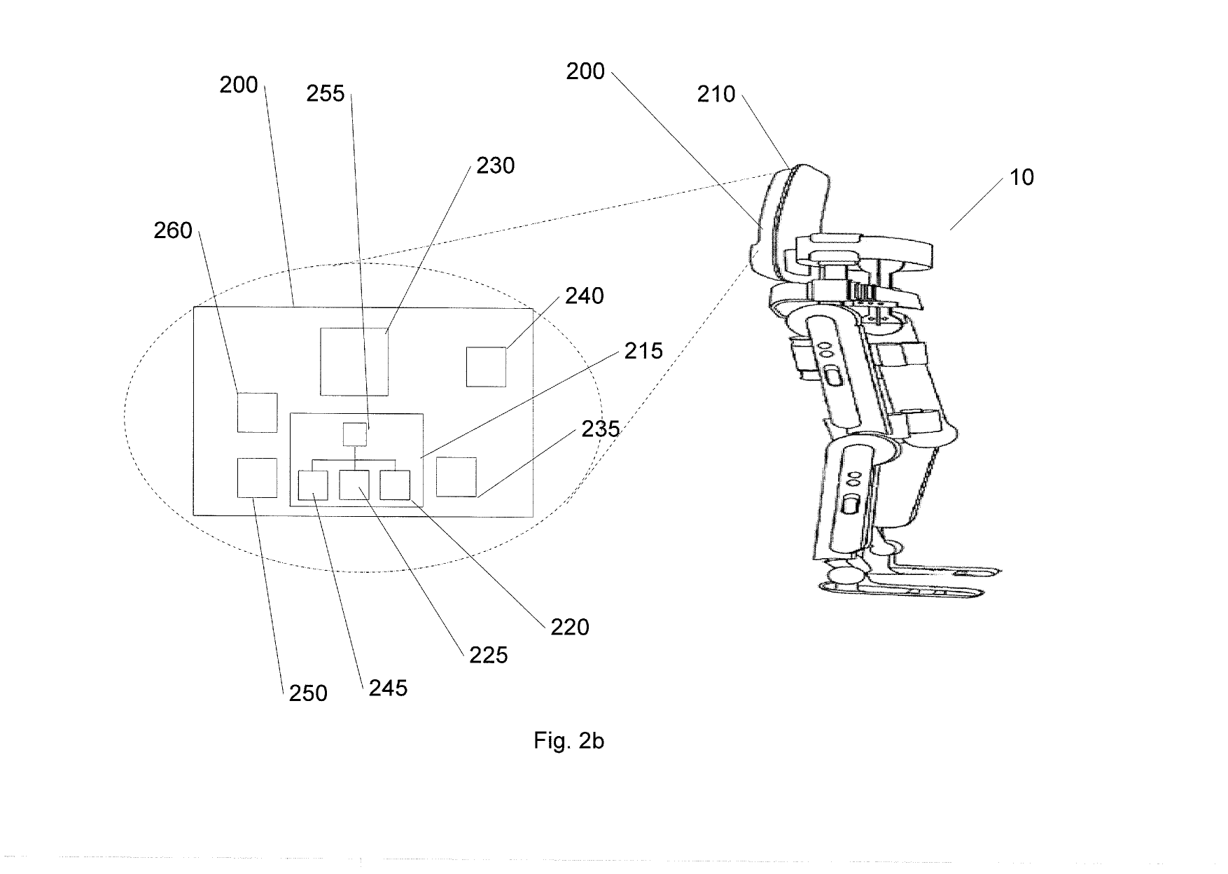

FIG. 2a is a schematic illustration of an airbag unit connected to a user, according to an example.

Airbag unit 200 may be coupled to user 5 via straps 210. In some embodiments of the invention, other methods of coupling airbag unit 200 to user 5 may also be used. Airbag unit 200 may be a knapsack or similar bag that can be coupled to user 5. In some examples, airbag unit may be a vest or other form of clothing worn by user 5. In some embodiments, airbag unit 200 may have other uses, and may be usable to carry objects in addition to deploying an airbag 250.

In some embodiments of the invention, airbag unit 200 may be a clothing accessory, including a belt. In some embodiments of the invention, airbag unit 200 may include multiple units coupled mechanically, wired, wirelessly or otherwise in communication with each other. The multiple units may be in communication with other devices as well.

Airbag unit 200 may include a fall detection unit 215. Fall detection unit 215 may include accelerometer 220, the accelerometer typically configured to provide data to assess whether or not user 5 is falling. Fall detection unit 215 may also include an angular velocity sensor 225 and/or gyro sensors 245. In some embodiments, fall detection unit 215 may also include a processor 255, the processor configured to determine the direction and speed of the potential fall of user 5.

In some embodiments of the invention, airbag unit may include a manual inflation control unit 235, the manual inflation control unit configured to allow user 5 to inflate one or a plurality of airbags independent of sensor data.

In some examples, airbag unit 200 includes other sensors; the sensors may be configured to provide data for assessing if user 5 is falling, and in some embodiments, to provide data to determine how to deploy one or a plurality of airbags 250. Airbags 250 may to be included within airbag unit 200 such that airbags 250 rapidly deploy. Airbags 250 may be of a cushion type, tubular type or other types known in the art.

Airbags 250 may be configured to deploy on the back and/or around the waist of user 5. Airbags 250 may also deploy in other areas of deployment, as are known in the art.

In some embodiments, airbag unit 200 includes a control unit 230; the control unit may be configured to provide controlling functions over airbag unit 200. In some examples, airbag unit 200 includes a power unit 240. Power unit 240 may be a battery, fuel cell or a solar cell, as are known. In some embodiments of the invention, power unit 240 may allow for the coupling of an external energy source.

Airbag unit 200 may include, in some instances, an inflation unit 260. In some embodiments of the invention, airbag unit 200 includes one or a plurality of inflation units, each unit configured to be attached to one or a plurality of airbags 250.

In some embodiments of the invention, inflation unit 260 includes compressed gas, e.g., a CO₂ cartridge. In some examples, a triggering mechanism, e.g. mechanical, electronic or another known technology may be employed to trigger the release of the compressed gas. The compressed gas may be contained in a cylinder or other container. In some embodiments, the cylinder is refillable. The release of the compressed gas is may be via a puncture of the cylinder or container, or via a small, controlled explosion, or another method.

In some embodiments, inflation unit 260 includes technology for generating a gas as the result of a chemical reaction, as known in the art, with an electronic triggering mechanism. In some embodiments of the invention airbags 250 may contain a mixture of NaN₃, KNO₃, and SiO₂. The mixture may be ignited via an electrical impulse. The ignited mixture may, in some instances, generate nitrogen gas, the gas filling the airbag. In some embodiments, KNO₃ and SiO₂ may be employed to remove the sodium metal by converting it to a harmless material.

FIG. 2b is a schematic illustration of an airbag coupled to an exoskeleton according to an example.

Airbag unit 200 may be coupled to motorized exoskeleton device 10 via straps 210. In some examples, other methods of coupling airbag unit 200 to motorized exoskeleton device 10 may also be used. Typically, airbag unit 200 is a container, e.g., a bag that can be coupled to motorized exoskeleton device 10. In some embodiments of the invention, airbag unit 200 may be coupled to, or part of, backpack 130, backpack 130 described above.

In some embodiments, airbag unit 200 may include multiple units coupled mechanically, wired, wirelessly, or otherwise in communication with each other.

Airbag unit 200 may include a fall detection unit 215. Fall detection unit 215 may include accelerometer 220, the accelerometer typically configured to provide data to assess whether or not user 5 is falling. Fall detection unit 215 may also include an angular velocity sensor 225 and/or gyro sensors 245. In some examples, fall detection unit 215 may also include a processor 255, the processor configured to determine the direction and speed of the potential fall of user 5.

In some embodiments of the invention, fall detection unit 215 may be coupled wirelessly or via a wired connection to one or a plurality of sensor units 120, e.g., a tilt sensor on motorized exoskeleton device 10, the tilt sensor configured to provide data to assess whether or not user 5 is falling. In some embodiments, the tilt sensor may determine whether or not user 5 is falling.

In some embodiments of the invention, airbag unit may include a manual inflation control unit 235, the manual inflation control unit configured to allow user 5 to inflate one or a plurality of airbags independent of sensor data.

In some embodiments, airbag unit 200 includes other sensors, the sensors may, in some instances be configured to provide data for assessing if user 5 is falling, and in some examples, to provide data to determine how to deploy one or a plurality of airbags 250. Airbags 250 may be included within airbag unit 200 such that airbags 250 rapidly deploy. Airbags 250 may be of a cushion type, tubular type or other airbag types known in the art.

In some embodiments, airbags 250 may be configured to deploy on the back and/or around the area of the waist of user 5. Airbags 250 may also deploy in other areas of deployment as known in the art.

In some embodiments of the invention, airbag unit 200 includes a control unit 230, the control unit may be configured to assess, typically via algorithms, whether user 5 is falling, based on data, the data including data from accelerometer 220 or other sensors. In some embodiments, airbag unit 200 includes a power unit 240. Power unit 240 may be a battery, fuel cell or a solar cell, as are known. In some examples, power unit 240 allows for the coupling of an external energy source.

Airbag unit 200 includes an inflation unit 260. In some embodiments, airbag unit 200 includes one or a plurality of inflation units, each unit configured to be attached to one or a plurality of airbags 250.

In some embodiments, inflation unit 260 includes compressed gas technology. In some instances, the compressed gas technology may include a CO2 cartridge. In some examples, triggering mechanisms, typically mechanical, electronic or another known technology is employed to trigger the release of the compressed gas, as described above. In some embodiments of the invention, inflation unit 260 includes technology generating a gas as the result of a chemical reaction, as known in the art, and as described above, typically with an electronic triggering mechanism.

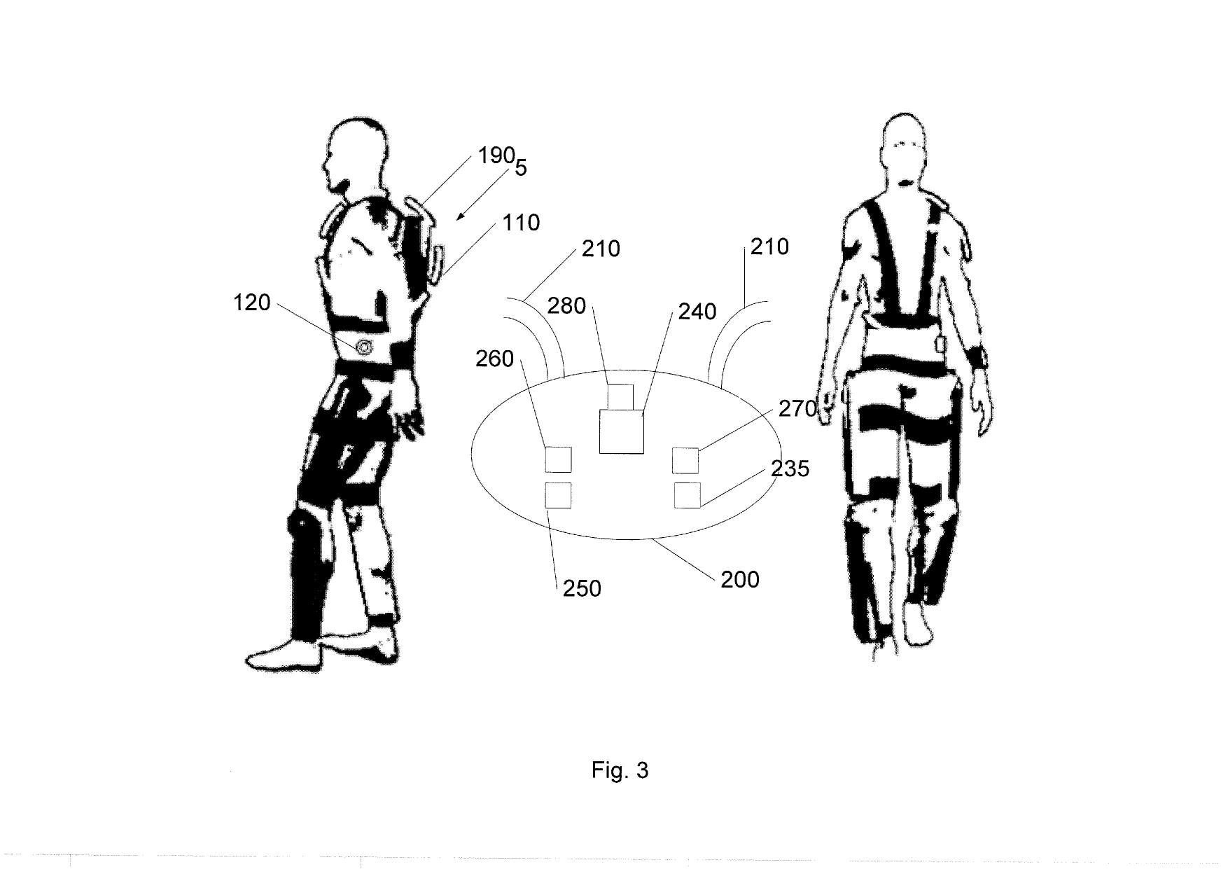

FIG. 3 is a schematic illustration of an airbag connected to sensors in a motorized exoskeleton device, according to an example of the invention.

In some embodiments of the invention, airbag unit 200 may be coupled to motorized exoskeleton device 10 as described above. Airbag unit 200 may be container, e.g., a bag that can be coupled to motorized exoskeleton device 10.

In some examples, airbag unit 200 may be coupled to user 5 via straps 210. In some embodiments, other methods of coupling airbag unit 200 to user 5 may also be used. In some embodiments of the invention, airbag unit 200 may be a knapsack, backpack, or similar bag that can be coupled to or worn by user 5. In some embodiments of the invention, airbag unit may be a vest or other form of clothing worn by user 5. In some examples, airbag unit 200 may have other uses, and, may be usable to carry objects in addition to deploying an airbag 250.

In some embodiments, airbag unit 200 may include multiple units coupled mechanically, wired, wirelessly or otherwise in communication with each other.

Airbag unit 200 may be coupled mechanically, wired, and/or wirelessly with one or a plurality of sensor units 120 and control unit 110 within motorized exoskeleton device 10, described above.

In some examples, airbag unit 200 may be coupled wirelessly or via a wired connection to one or a plurality of sensor units 120, e.g., a tilt sensor on motorized exoskeleton device 10, the tilt sensor configured to provide data to assess whether or not user 5 is falling. In some embodiments, the tilt sensor may determine whether or not user 5 is falling.

In some embodiments of the invention, airbag unit 200 may include a manual inflation control unit 235, the manual inflation control unit configured to allow user 5 to inflate one or a plurality of airbags independent of sensor data.

Airbags 250 may be included within airbag unit 200 such that airbags 250 rapidly deploy. Airbags 250 may be of a cushion type, tubular type or other types known in the art.

In some instances, airbags 250 may be configured to deploy on the back and/or around the waist area of user 5. Airbags 250 may also deploy in other areas of deployment as known in the art.

In some embodiments of the invention, airbag unit 200 includes a communication unit 270, the communication unit may be configured to be in communication with control unit 110 and/or sensor units 120 within motorized exoskeleton device 10.

In some embodiments, airbag unit 200 includes a power unit 240. Power unit 240 may be a battery, fuel cell or a solar cell, as are known. In some examples, power unit 240 allows for the coupling of an external energy source. In some embodiments, airbag unit 200 may have a coupling 280 to receive power from power unit 190, the power unit described above and coupled to motorized exoskeleton device 10. In some embodiments of the invention, the power may be transferred via a physical connection. In some embodiments, the power maybe transferred wirelessly.

In some embodiments of the invention, airbag unit 200 includes an inflation unit 260. In some embodiments, airbag unit 200 includes one or a plurality of inflation units, each unit configured to be attached to one or a plurality of airbags 250.

A triggering mechanism may be in communication with control unit 110 to determine when to inflate one or a plurality of airbags 250.

In some embodiments of the invention, inflation unit 260 includes compressed gas technology, as described above. In some examples, inflation unit 260 includes gas generating technology, as described above.

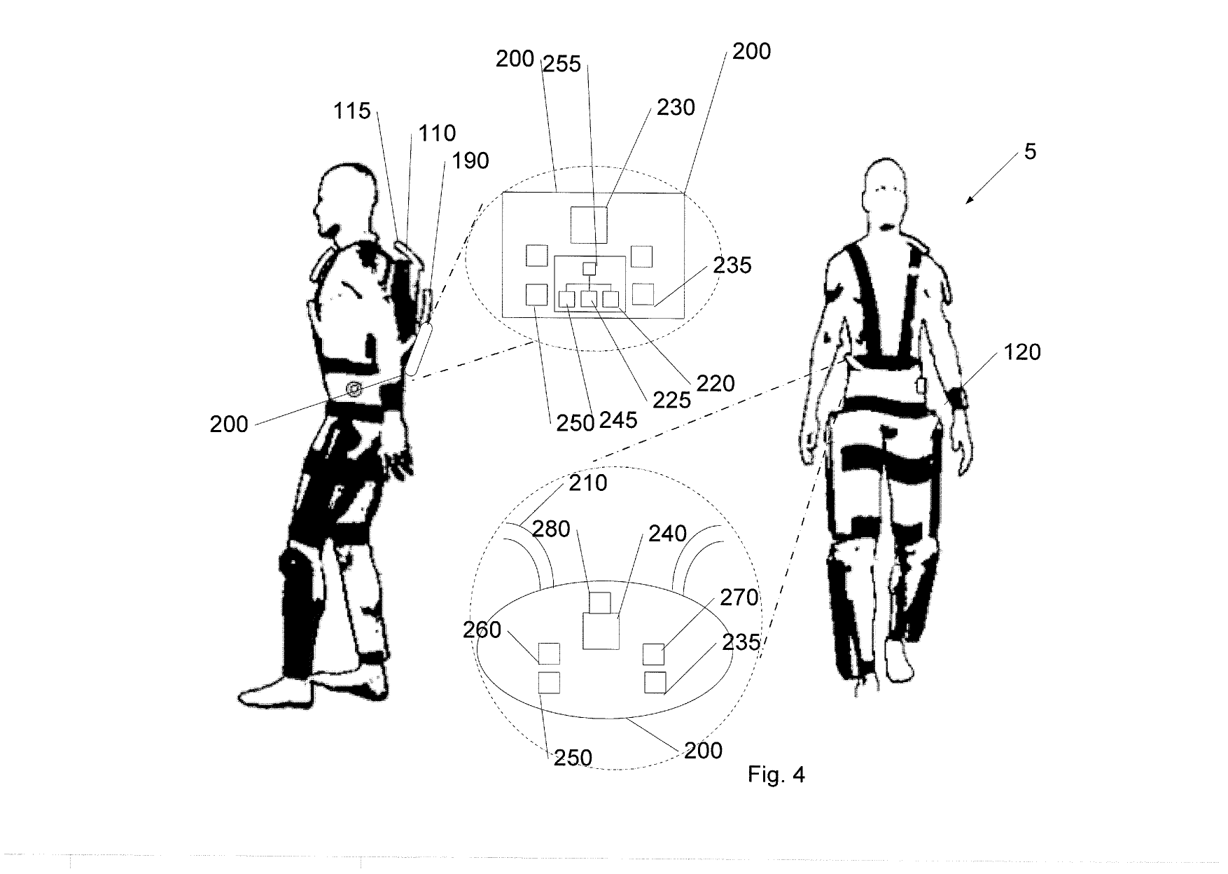

FIG. 4 is a schematic illustration of a motorized exoskeleton device with redundant airbag related units, according to an example.

An airbag unit 200, as described above, may be coupled to user 5 as described above. Airbag unit 200, as described above, may be coupled to motorized exoskeleton device 10, as described above.

In some embodiments, airbag unit 200 is coupled mechanically, wired and/or wirelessly with one or a plurality of sensor units 120 and control unit 110 within motorized exoskeleton device 10, described above.

In some embodiments, airbag unit 200 includes a control unit 230, the control unit may be configured to assess, typically via algorithms whether user 5 is falling, based on data, the data including data from accelerometer 220 and other sensors.

Airbag unit may also include a fall detection unit 215. Fall detection unit 215 may include accelerometer 220, the accelerometer typically configured to provide data to assess whether or not user 5 is falling. Fall detection unit 215 may also include an angular velocity sensor 225 and/or gyro sensors 245. In some examples, fall detection unit 215 may also include a processor 255, the processor configured to determine the direction and speed of the potential fall of user 5.

In some embodiments of the invention, the sensors 120, control unit 110, sensors within fall detection unit 215 and/or processor 255 may be redundant with each other.

In some embodiments, fall detection unit 215 may be coupled wirelessly or via a wired connection to one or a plurality of sensor units 120, e.g., a tilt sensor on motorized exoskeleton device 10, the tilt sensor configured to provide data to assess whether or not user 5 is falling. In some examples, the tilt sensor may determine whether or not user 5 is falling.

Airbag unit 200 may include an inflation unit 260. In some embodiments, airbag unit 200 includes one or a plurality of inflation units, each unit configured to be attached to one or a plurality of airbags 250.

In some embodiments, inflation unit 260 includes compressed gas technology, e.g., a CO2 cartridge. In some embodiments of the invention, triggering mechanisms, typically mechanical, electronic or another known technology is employed to trigger the release of the compressed gas.

In some instances, a triggering mechanism may be in communication with control unit 110 to determine when to inflate one or a plurality of airbags 250. The triggering mechanism may also be in communication with control unit 230.

Airbags 250 may be inflated via compressed air, and/or gas generating technology, as described above.

In some embodiments, airbag unit 200 includes a power unit 240. Power unit 240 may be a battery, fuel cell or a solar cell, as are known. In some examples, power unit 240 allows for the coupling of an external energy source. In some embodiments, airbag unit 200 may have a coupling 280 to receive power from power unit 190, the power unit described above and coupled to motorized exoskeleton device 10.

Control unit 110 may be configured to execute programs and algorithms, some of the programs and algorithms, as are known in the art, via an incorporated processor 115, the processor configured to run algorithms to determine whether to deploy one or a plurality of airbags 250 when conflicting data is returned from sensors 120, and/or the sensors conflict, and fall detection unit 215, e.g., when one or a plurality of the sensors associated with one of a plurality of airbags 250 conflicts.

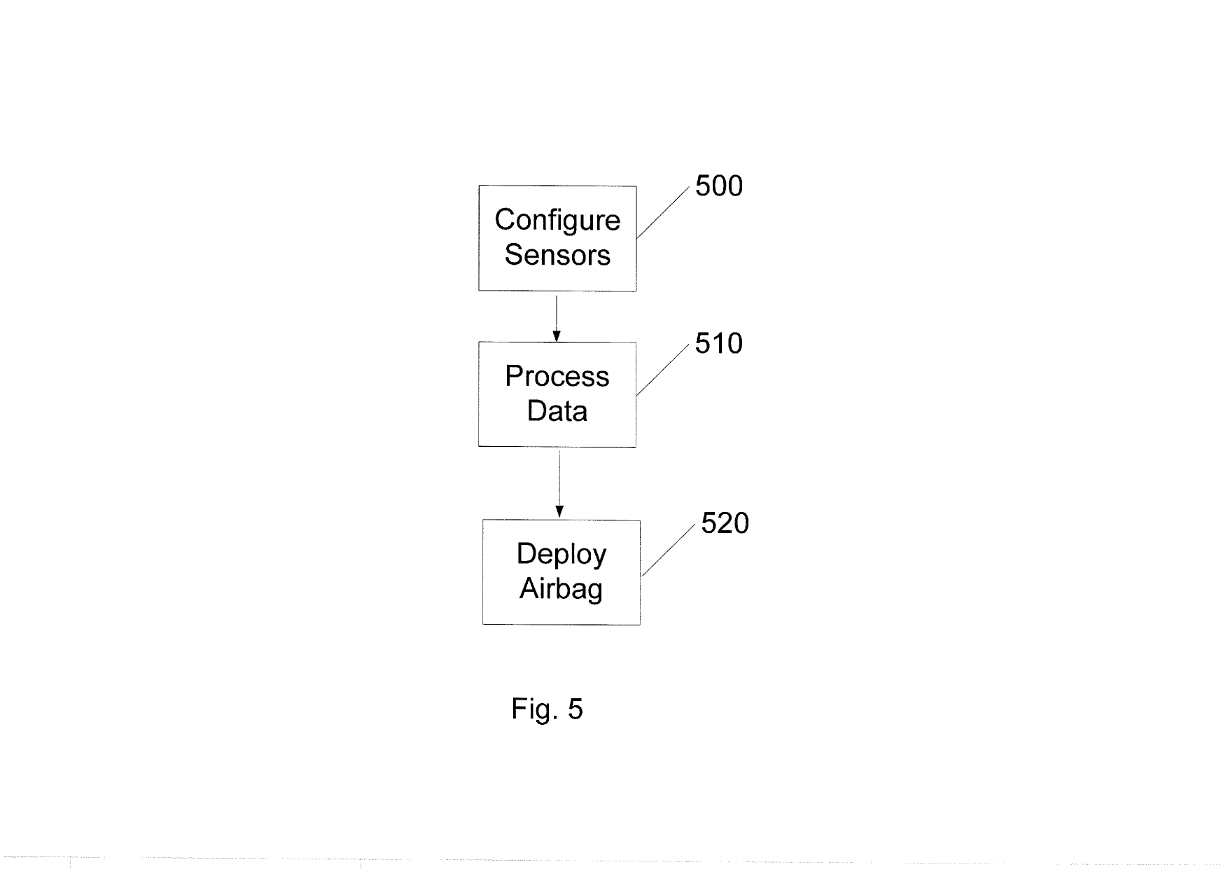

FIG. 5 is a flowchart describing a method, according to an example. Typically, a method for deploying one or a plurality of airbags 250, the airbags 250 associated with the use of motorized exoskeleton device 10, includes configuring one or a plurality of sensors, the sensors may be either in motorized exoskeleton device 10 or air bag unit 200, or both, to record parameters related to whether user 5 of motorized exoskeleton device 10 is falling, as depicted in block 500.

Block 510 depicts the step of configuring a processor, the processor either processor 255 in air bag unit 200, control unit 110 or a portion thereof, or both, to determine, based on the recorded parameters, if user 5 of motorized exoskeleton device 10 is falling. In some examples, falling presents a safety issue to user 5.

Block 520 depicts a step of configuring one or a plurality of airbags 250 in airbag unit 200, the airbag unit configured to be placed on user 5, motorized exoskeleton device 10 or both, to deploy if the processor, as described above, determines that user 5 of motorized exoskeleton device 10 is falling.

Examples of the present invention may include apparatuses for performing the operations described herein. Such apparatuses may be specially constructed for the desired purposes, or may comprise computers or processors selectively activated or reconfigured by a computer program stored in the computers. Such computer programs may be stored in a computer-readable or processor-readable non-transitory storage medium, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions. It will be appreciated that a variety of programming languages may be used to implement the teachings of the invention as described herein. Examples of the invention may include an article such as a non-transitory computer or processor readable non-transitory storage medium, such as for example, a memory, a disk drive, or a USB flash memory encoding, including or storing instructions, e.g., computer-executable instructions, which when executed by a processor or controller, cause the processor or controller to carry out methods disclosed herein. The instructions may cause the processor or controller to execute processes that carry out methods disclosed herein.

Different embodiments of the invention are disclosed herein. Features of certain embodiments may be combined with features of other embodiments; thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. An exoskeleton system comprising:
a motorized exoskeleton device;
one or a plurality of sensors to sense one or a plurality of parameters indicative of a state in which a user of the motorized exoskeleton device is falling; and,
an airbag unit comprising one or a plurality of airbags configured to deploy in response to the sensed state.

2. The system of claim 1, wherein the airbag unit is configured to be worn by the user.

3. The system of claim 1, wherein the airbag unit is configured to be coupled to the motorized exoskeleton device.

4. The system of claim 1, wherein the one or plurality of sensors are configured to be in the airbag unit worn by the user.

5. The system of claim 1, wherein the one or plurality of sensors are configured to be coupled to the motorized exoskeleton device.

6. The system of claim 1, wherein a processor to processes the signals is configured to be in the airbag unit worn by the user.

7. The system of claim 6, wherein the processor is configured to be coupled to the motorized exoskeleton device.

8. The system of claim 1, wherein a first set of the one or plurality of sensors are configured to be worn by the user, and a second set of the one or plurality of sensors are configured to be coupled to the motorized exoskeleton device.

9. The system of claim 8 wherein one of the sets of the one or plurality of sensors are configured to be redundant with regard to the other set of one or a plurality of sensors.

10. The system of claim 8, wherein a processor is configured to assess whether to deploy one or a plurality of airbags when the first set of one or a plurality of sensors conflicts with the second set of one or a plurality of sensors.

11. A method enhancing the safety of a user of a motorized exoskeleton device, the method comprising:
configuring one or a plurality of sensors to sense one or a plurality of parameters indicative of a state in which a user of the motorized exoskeleton device is falling; and,
configuring an airbag unit comprising one or a plurality of airbags configured to deploy in response to the sensed state.

12. The method of claim 11, wherein configuring one or a plurality of sensors to sense one or a plurality of parameters indicative of a state in which a user of the motorized exoskeleton device is falling, comprises configuring the one or a plurality of sensors to be coupled to the user.

13. The method of claim 11, wherein configuring one or a plurality of sensors to sense one or a plurality of parameters indicative of a state in which a user of the motorized exoskeleton device is falling, comprises configuring the one or a plurality of sensors to be coupled to the motorized exoskeleton device.

14. The method of claim 11, further comprising configuring the airbag unit to be worn by the user.

15. The method of claim 11, further comprising configuring the airbag unit to coupled to the motorized exoskeleton device.

16. The method of claim 11, further comprising configuring a processor to be coupled to the motorized exoskeleton device.

17. The method of claim 11, further comprising configuring a processor to be worn by the user.

18. The method of claim 11, further comprising, configuring a first set of the one or plurality of sensors to be worn by the user, and configuring a second set of the one or plurality of sensors to be coupled to the motorized exoskeleton device, wherein one of the sets of the one or plurality of sensors are configured to be redundant with an other set of one or a plurality of sensors.

19. The method of claim 18, further comprising configuring a processor to assess whether to deploy one or a plurality of airbags when the first set of one or a plurality of sensors conflicts with the second set of one or a plurality of sensors.
